(19) United States
(12) Patent Application Publication
(10) Pub. No.: US 2022/0207043 A1
(43) Pub. Date: Jun. 30, 2022

(54) ENTITY DATA SERVICES FOR VIRTUALIZED COMPUTING AND DATA SYSTEMS

(71) Applicant: VMware, Inc., Palo Alto, CA (US)

(72) Inventors: Sufian A. DAR, Bothell, WA (US); Deep P. DESAI, Sammamish, WA (US); Sripriya VENKATESH PRASAD, Bothell, WA (US); Nandesh Amit GURU, Kirkland, WA (US); Omurbek KADYBREKOV, Bishkek (KG)

(73) Assignee: VMware, Inc., Palo Alto, CA (US)

(21) Appl. No.: 17/135,604

(22) Filed: Dec. 28, 2020

(51) Int. Cl. G06F 16/2455; G06F 9/455; G06F 16/901; G06F 16/28; G06F 16/25; G06F 9/54

(52) U.S. Cl. CPC G06F 16/24568; G06F 9/45558; G06F 16/9024; G06F 2009/45595; G06F 16/258; G06F 9/54; G06F 16/288

(57) ABSTRACT

Techniques for providing virtualized entity-related services to a group of users are provided. The techniques include collecting entity-related data from multiple cloud providers. The data is collected via a data stream. Various portions of the data stream are stored in various databases. A portion of the data stream is stored in a graph database that stores relationships between the entities. A portion of the data stream is stored in a key-value database that persistently stores historical virtualized entity data for the group of users. A portion of the data stream is stored in a reverse-indexed database that stores globally-searchable entity data for the entities. A search query is received. Based on the content of the query, a combination of the databases searched. Search results are compared to policies or rules of the group. If an entity is out of compliance, a warning is issued and remedial action taken.

### FIELD

The present disclosure relates generally to distributed-computing systems and, more specifically, to methods and systems that enable providing entity data services for virtualized computing and data systems.

### BACKGROUND

Modern computing systems provide distributed and virtualized entities for computing and data services. Such services may be provided by a software designed data center (SDDC) that may implement one or more virtual storage area networks (e.g., a vSAN) and a virtual disk file system (e.g., a vDFS). These distributed systems provide virtualized entities (e.g., virtual machines, virtual storage disks, virtual network components, and the like) to users within a cloud-computing environment. For instance, cloud providers may provide virtualized entities to an organization to generate and operate the organization's computing “cloud.” Often, a user of the organization may be responsible for managing and maintaining compliance of these entities with policies of the organization and/or cloud provider. For example, a group of users may be allotted with a maximum number for a particular entity type, a particular entity may not consume more than an allotted amount of resources (e.g., CPU cycles, storage volume, network bandwidth), and the like. The user tasked with managing and maintaining the organization's cloud may routinely query the entities to determine the entities' status and/or compliance with respect to the policies. Some of these systems may be comprised of hundreds or even thousands of such entities. Thus, the manual operations required to manage and maintain an organization's cloud may be cumbersome and/or complex.

These entities may be provided by more than one cloud providers. For example, a first cloud provider may provide some of the virtual machines, while another provider may provide other virtual machines. Each cloud provider may have their own query system and/or syntax. Thus, the task of maintaining such a cloud is increased because the user may have to target their queries across multiple inconsistent systems. Thus, there is a need for an entity-related data service that is harmonized and unified across multiple platforms.

Overview

Described herein are techniques, for entity data services for virtualized computing and data systems. In one embodiment, a method for providing virtualized entity-related data services to a group of users is performed. The method may include receiving a data stream. The data stream encodes current state-information of a plurality of virtualized entities. Each virtualized entity of the plurality of entities may be provided by one or more virtualized-entity providers of a set of virtualized-entity providers. A graph database may be updated based on the received data stream. The graph database stores current graph data that indicates a plurality of current relationships between virtualized entities of the plurality of virtualized entities. A key-value database may be updated based on the received data stream. The key-value database may persistently store historical virtualized entity data for the group of users. A reverse-indexed database may be updated based on the received data stream. The reverse-indexed database stores globally-searchable current entity data for the plurality of virtualized entities. In response to receiving a query, one or more databases of the graph, key-value, and reverse-indexed databases may be identified based on content of the query. In response to providing the query to the one or more identified databases, search results may be received from each of the one or more identified databases. The search results received from each database of the one or more identified databases may be aggregated. The aggregated search results may encode a status of at least a first virtualized entity of the plurality of virtualized entities. An indication of the status of the first virtualized entity may be provided.

In one embodiment, a non-transitory computer-readable storage medium storing one or more programs configured to be executed by one or more processors is provided. The one or more programs stored by the non-transitory computer-readable storage medium include instructions for performing operations that are executable by a distributed computing system that provides virtualized entity-related data services to a group of users. The operations may include receiving a data stream. The data stream encodes current state-information of a plurality of virtualized entities. Each virtualized entity of the plurality of entities may be provided by one or more virtualized-entity providers of a set of virtualized-entity providers. A graph database may be updated based on the received data stream. The graph database stores current graph data that indicates a plurality of current relationships between virtualized entities of the plurality of virtualized entities. A key-value database may be updated based on the received data stream. The key-value database may persistently store historical virtualized entity data for the group of users. A reverse-indexed database may be updated based on the received data stream. The reverse-indexed database stores globally-searchable current entity data for the plurality of virtualized entities. In response to receiving a query, one or more databases of the graph, key-value, and reverse-indexed databases may be identified based on content of the query. In response to providing the query to the one or more identified databases, search results may be received from each of the one or more identified databases. The search results received from each database of the one or more identified databases may be aggregated. The aggregated search results may encode a status of at least a first virtualized entity of the plurality of virtualized entities. An indication of the status of the first virtualized entity may be provided.

In one embodiment, a distributed computing system for providing virtualized entity-related data services to a group of users may include one or more processors and memory. The memory may store one or more programs configured to be executed by the one or more processors. The one or more programs include instructions for performing operations comprising receiving a data stream. The data stream encodes current state-information of a plurality of virtualized entities. Each virtualized entity of the plurality of entities may be provided by one or more virtualized-entity providers of a set of virtualized-entity providers. A graph database may be updated based on the received data stream. The graph database stores current graph data that indicates a plurality of current relationships between virtualized entities of the plurality of virtualized entities. A key-value database may be updated based on the received data stream. The key-value database may persistently store historical virtualized entity data for the group of users. A reverse-indexed database may be updated based on the received data stream. The reverse-indexed database stores globally-searchable current entity data for the plurality of virtualized entities. In response to receiving a query, one or more databases of the graph, key-value, and reverse-indexed databases may be identified based on content of the query. In response to providing the query to the one or more identified databases, search results may be received from each of the one or more identified databases. The search results received from each database of the one or more identified databases may be aggregated. The aggregated search results may encode a status of at least a first virtualized entity of the plurality of virtualized entities. An indication of the status of the first virtualized entity may be provided.

### BRIEF DESCRIPTION OF THE DRAWINGS

FIG. 1A is a block diagram illustrating a system and environment for implementing various components of a distributed-computing system, in accordance with some embodiments.

FIG. 1B is a block diagram illustrating a containerized application framework for implementing various components of a distributed-computing system, in accordance with some embodiments.

FIG. 2 is a block diagram illustrating a virtual storage area network (vSAN), in accordance with some embodiments.

FIG. 3 is a block diagram illustrating a system enabling entity data services, in accordance with some embodiments.

FIG. 4 illustrates a flowchart of an exemplary process for providing entity-related data services, in accordance with some embodiments.

FIG. 5 illustrates a flowchart of an exemplary process for providing automated entity-compliance services, in accordance with some embodiments.

### DETAILED DESCRIPTION

In the following description of embodiments, reference is made to the accompanying drawings in which are shown by way of illustration specific embodiments that can be practiced. It is to be understood that other embodiments can be used and structural changes can be made without departing from the scope of the various embodiments.

Distributed computing systems, such as software designed data centers (SDDCs), may implement one or more virtual storage area networks (vSANs), which provide virtualized entities such as virtualized machines (VMs), virtualized data storage components (e.g., virtualized disks), virtualized network components, and the like. Such a virtualized computing component and/or service may be herein referred to as an entity. An entity may be a resource or asset. Thus, the terms “entity,” “asset,” or “resource,” may be employed interchangeably throughout. Entities are not limited to VMs and virtualized storage disks, and may include other virtualized components that offer various computing and/or data services via virtualized components, such as virtualized load balancers, gateways, user authentication components, security components, and the like. Such entities may be provided to a group of users (e.g., one or more employees of an organization) by one or more cloud-based computing service providers (e.g., cloud providers). A group of users may be associated with an organization, company, or the like. For example, a technology company may use multiple cloud providers to provide a set virtualized entities that comprise the company's “cloud.” The virtualized entities of the technology company's cloud provides computing and/or data services to customers of the company. As used herein, the term “cloud” may refer to any set of physical and/or virtual entities that are associated with a group. A cloud may be associated with a group. One or more cloud providers may provide the entities of any cloud. For example, the group may be company, and the group's cloud may include one or more vSANs, SDDCs, and the like. A first subset of the entities of the cloud may be provided by a first service provider, a second subset of the entities of a cloud may be provided by a second subset, and a third subset of the entities of the cloud may be provided by a third cloud provider.

A cloud may be created, monitored, and maintained such that the cloud remains in compliance with the needs and/or restrictions of the associated group of users and/or the cloud providers. That is, a cloud may be managed to remain in compliance with one or more policies associated with the group, their entities, or a cloud provider. A subset of the group of users may be tasked with managing the cloud for the group of users. Each user of the group of users may have a cloud account. Managing a cloud may include allocating new entities, deallocating (or terminating) stale or expired entities, resynchronizing stale entities, and ensuring each of the entities, each of the users, and the group as a whole maintains compliance with the one or more associated policies. One or more entity policies may be associated with one or more entities. One or more user policies may be associated with one or more users. One or more group policies may be associated with one or more groups. One or more provider policies may be associated with one or more cloud providers. Non-limiting examples of such policies include: a given group may be allowed to have a maximum number of VMs deployed at any one time; a specific VM may only be allowed to be deployed for a predetermined time period; an entity, a user, or a group may be only allocated a maximum volume of a virtualized computing resource (network bandwidth); a virtual disk may be only enabled to access a certain storage volume; and the like. Managing a cloud may include monitoring the entities and the one or more policies to ensure that each entity and the group is compliant with their associated policies.

Managing a cloud may include routinely querying the group's currently deployed entities to determine various information (or data) of the entities. Such information may be employed to ensure that the group, the group's users, and the group's entities stay in compliance with all applicable policies. Such queries may include, but are not limited to, how many entities of each entity type are currently deployed; which user (or group of users) has the most entities currently deployed; what are the relationships and/or dependencies between a subset of the entities; which entities have “child” or “parent” relationships and/or dependencies to other entities; which entities are provided by which cloud providers; and the like. Such queries may include queries regarding historical, but no longer existing entities.

In modern systems, a group of users may have hundreds, thousands, or even tens of thousands of currently deployed entities in their “cloud.” Thus, managing such a modern cloud may be difficult, complex, and/or cumbersome. The dynamic nature of modern clouds increase the difficulty in managing a cloud. For example, based on fluctuations of user demand, virtualized entities are routinely allocated and/or deallocated, and thus the set of currently extent entities may significantly vary over time. Still further increasing the difficultly of managing a cloud may be that the entities are provided by multiple cloud providers, with separate mechanisms (e.g., syntaxes for allocating and deallocating entities, querying the entities, and the like). For instance, a first subset of the group's entities may be provided by a first cloud provider, a second subset of the group's entities may be provided by a second cloud provider, and a third subset of the group's entities may be provided by a third cloud provider. Each cloud provider may provide separate and/or inconsistent mechanisms to query state information of the entities that they provide.

As such, in some embodiments, entity-related data services are provided to groups of user. The various embodiments herein are enabled to provide data to users of a group that indicates various information on any set of virtualized entities. That is, in some the embodiments, users are enabled to query and receive search results for current and/or historical information relating to any of their entities. An integrated platform is provided that accepts queries for entity information that is not specific to the cloud provider and/or not specific to a query type. That is, users of a group are not required to employ separate systems, separate search engines, and/or separate queries to request information about their entities and/or to manage their cloud. In some embodiments, automated management services are provided. For instance, in one embodiment, current state of the group's cloud may be monitored, via the entity data services, and the current state is compared to each of the policies associated with the group. If one or more entities become in violation (or out of compliance) with one or more of the policies, an automated warning message may be provided to one or more users of the group, such that the user may take action to bring the cloud entities back into compliance. In at least one embodiment, one or more automated actions may be taken to update one or more entities to bring the cloud back into compliance with the one or more violated policies.

More specifically, in some the embodiments, an entity data service system collects and integrates entity-related data from each of the cloud providers that provides one or more entities comprising the groups cloud. The entity-related data provided by the cloud providers may be in the form of a real-time data stream. The data stream from each of the cloud providers may encode state-information of the respective entities. State-information of a particular entity may include any current information (or data) related to the particular entity. For example, the state-information may include a current status of an entity, a current bandwidth of the entity, a current utilization of the entity, a timestamp associated with the entity (e.g., a timestamp indicating its creation or allocation, its expected expiration or deallocation) its current relationships to one or more other entities, its current size, its current owner, and the like.

In some embodiments, the data streams from the one or more cloud providers are collected, aggregated, and ingested, via a streaming service (e.g., a data stream integrator). More specifically, a data stream collector (e.g., Amazon Kinesis) may collect, aggregate, process, and/or at least partially analyze the data streams from the cloud providers. Upon collecting and aggregating the data streams, the data stream may be ingested, and at least portions of the entity-related data encoded data stream are stored in one or more databases. Some embodiments may include at least three separate databases. One of the databases may be a graph database configured to store relationships and/or dependencies of currently deployed entities, another database may be a key-value based database configured to store the current and historical state information of the entities, and another database may be an inverse-indexed (or Lucene-indexed) database configured to be searchable via a dynamic and distributed search engine. In some embodiments, a first database may be a graph database (e.g., Amazon Neptune), the second database may be a NoSQL database that includes a key-value store (e.g., Amazon DynamoDB), and a third database may be a database that supports unstructured and/or document-type data, such as but not limited to Elasticsearch or an Elasticsearch-type database. Some embodiments may include one or more search and analytic engines that are enabled to search each of the one or more databases for requested data, as well as analyze the data in the databases to generate analytics and/or metrics of the data.

Each of the databases may be intelligently sharded to ensure efficient lookups when servicing a query. That is, each of the databases may be intelligently partitioned into a plurality of shards or database slices, based on the group of users and the data, such that queried data may be efficiently located and retrieved from the databases. One or more policies of the group may indicate a sharding strategy for the databases. A policy may define one or more heuristics that indicates on which portions of the data content and/or data structures to partition the databases along. For instance, a policy may indicate a key for which to shard the database along. The sharding may be performed at the group or organizational level, the cloud account level, or the like. Some embodiments may be based on a representation state transfer (REST)-based architecture. Thus, these embodiments may support RESTful application programming interfaces (APIs) to implement at least some of its functionality. These embodiments may include RESTful APIs for querying the databases and for ingesting the data stream (e.g., updating each of the databases to include new entity-related data within the data stream). Some of the APIs may include SQL-style commands, operations, and/or syntax, while other APIs may include NoSQL-style commands, operations, and/or syntax. The APIs may include create, read, update, and delete (CRUD)—style commands, operation, and/or syntax.

The automated out-of-compliance warnings, queries, and query results may be provided to the user and/or the system via a query user interface (UI). Some embodiments support dynamic schemas, which may be configured at runtime. At least due to the intelligent sharding, these embodiments are highly scalable, as a group adds additional entities to their cloud. These embodiments provide high concurrency for both data ingestions and query servicing. Some embodiments may encrypt the data stored in each of the databases to ensure privacy. For additional privacy, the databases for a particular group of users may be isolated from the databases of other groups.

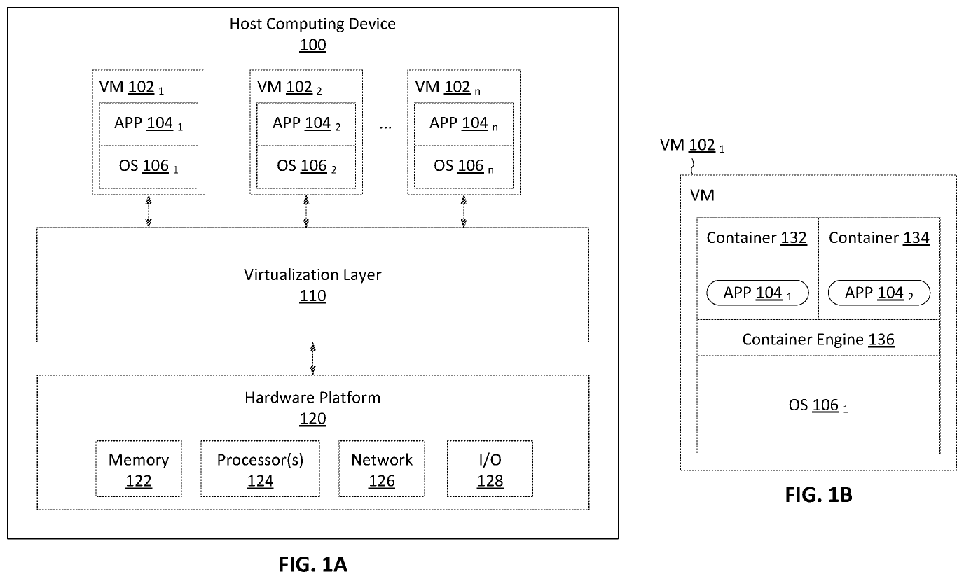

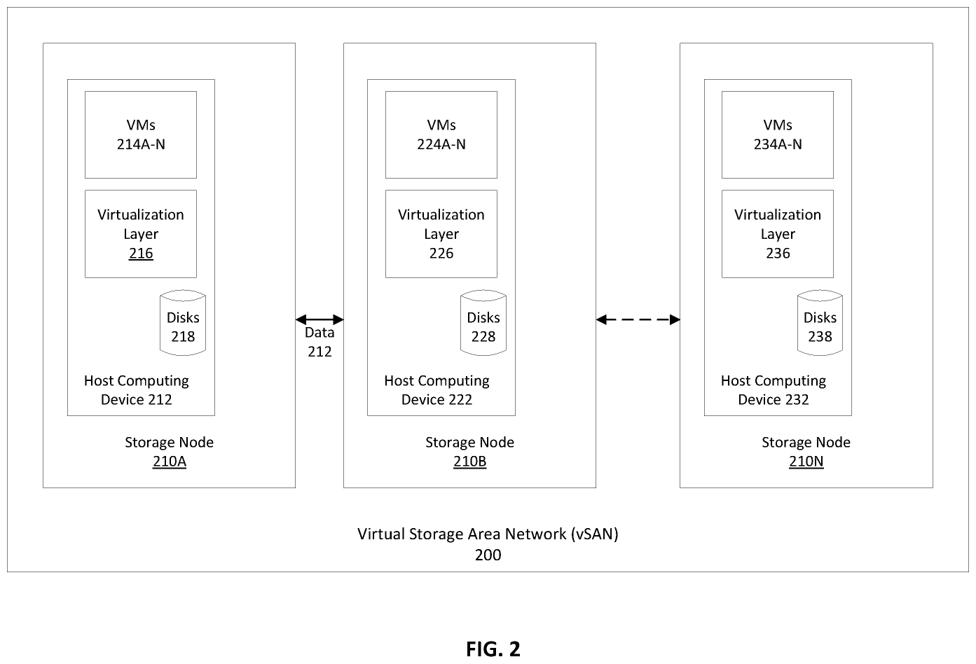

FIG. 1A is a block diagram illustrating a system and environment for implementing various components of a distributed-computing system, according to some embodiments. As shown in FIG. 1A, virtual machines (VMs) 102₁, 102₂ . . . 120ₙ are instantiated on host computing device 100. In some embodiments, host-computing device 100 implements one or more elements of a distributed-computing system (e.g., storage nodes of a vSAN 200 described with reference to FIG. 2). Hardware platform 120 includes memory 122, one or more processors 124, network interface 126, and various I/O devices 128. Memory 122 includes computer-readable storage medium. The computer-readable storage medium is, for example, tangible and non-transitory. For example, memory 122 includes high-speed random access memory and includes non-volatile memory, such as one or more magnetic disk storage devices, flash memory devices, NVMe devices, Persistent Memory, or other non-volatile solid-state memory devices. In some embodiments, the computer-readable storage medium of memory 122 stores instructions for performing the methods and processes described herein. In some embodiments, hardware platform 120 also includes other components, including power supplies, internal communications links and busses, peripheral devices, controllers, and many other components.

Virtualization layer 110 is installed on top of hardware platform 120. Virtualization layer 110, also referred to as a hypervisor, is a software layer that provides an execution environment within which multiple VMs 102 are concurrently instantiated and executed. The execution environment of each VM 102 includes virtualized components analogous to those comprising hardware platform 120 (e.g. a virtualized processor(s), virtualized memory, etc.). In this manner, virtualization layer 110 abstracts VMs 102 from physical hardware while enabling VMs 102 to share the physical resources of hardware platform 120. As a result of this abstraction, each VM 102 operates as though it has its own dedicated computing resources.

Each VM 102 includes operating system (OS) 106, also referred to as a guest operating system, and one or more applications (Apps) 104 running on or within OS 106. OS 106 (e.g., Darwin, RTXC, LINUX, UNIX, OS X, iOS, WINDOWS, or an embedded operating system such as VxWorks) includes various software components and/or drivers for controlling and managing general system tasks (e.g., memory management, storage device control, power management, etc.) and facilitates communication between various hardware and software components. As in a traditional computing environment, OS 106 provides the interface between Apps 104 (i.e. programs containing software code) and the hardware resources used to execute or run applications. However, in this case, the “hardware” is virtualized or emulated by virtualization layer 110. Consequently, Apps 104 generally operate as though they are in a traditional computing environment. That is, from the perspective of Apps 104, OS 106 appears to have access to dedicated hardware analogous to components of hardware platform 120.

FIG. 1B is a block diagram illustrating a containerized application framework for implementing various components of a distributed-computing system, in accordance with some embodiments. More specifically, FIG. 1B illustrates VM 102₁ implementing a containerized application framework. Containerization provides an additional level of abstraction for applications by packaging a runtime environment with each individual application. Container 132 includes App 104₁ (i.e., application code), as well as all the dependencies, libraries, binaries, and configuration files needed to run App 104₁. Container engine 136, similar to virtualization layer 110 discussed above, abstracts App 104₁ from OS 1061, while enabling other applications (e.g., App 104₂) to share operating system resources (e.g., the operating system kernel). As a result of this abstraction, each App 104 runs the same regardless of the environment (e.g., as though it has its own dedicated operating system). In some embodiments, a container (e.g., container 132 or 134) can include a gateway application or process, as well as all the dependencies, libraries, binaries, and configuration files needed to run the gateway applications.

It should be appreciated that applications (Apps) implementing aspects of the present disclosure are, in some embodiments, implemented as applications running within traditional computing environments (e.g., applications run on an operating system with dedicated physical hardware), virtualized computing environments (e.g., applications run on a guest operating system on virtualized hardware), containerized environments (e.g., applications packaged with dependencies and run within their own runtime environment), distributed-computing environments (e.g., applications run on or across multiple physical hosts) or any combination thereof. Furthermore, while specific implementations of virtualization and containerization are discussed, it should be recognized that other implementations of virtualization and containers could be used without departing from the scope of the various described embodiments.

FIG. 2 is a block diagram illustrating a virtual storage area network (vSAN) 200, in accordance with some embodiments. As described above, a vSAN is a logical partitioning of a physical storage area network. A vSAN divides and allocates a portion of or an entire physical storage area network into one or more logical storage area networks, thereby enabling the user to build a virtual storage pool. As illustrated in FIG. 2, vSAN 200 can include a cluster of storage nodes 210A-N, which can be an exemplary virtual storage pool. In some embodiments, each node of the cluster of storage nodes 210A-N can include a host-computing device. FIG. 2 illustrates that storage node 210A includes a host computing device 212; storage node 210B includes a host computing device 222, and so forth. In some embodiments, the host computing devices (e.g., devices 212, 222, 232) can be implemented using host computing device 100 described above. For example, as shown in FIG. 2, similar to those described above, host computing device 212 operating in storage node 210A can include a virtualization layer 216 and one or more virtual machines 214A-N (collectively as VMs 214). In addition, host computing device 212 can also include one or more disks 218 (e.g., physical disks) or disk groups. In some embodiments, VM 214 can have access to one or more physical disks 218 or disk groups via virtualization layer 216 (e.g., a hypervisor). In the description of this application, a storage node is sometimes also referred to as a host-computing device.

As illustrated in FIG. 2, data can be communicated among storage nodes 210A-N in vSAN 200. One or more storage nodes 210A-N can also be logically grouped or partitioned to form one or more virtual storage pools, such as clusters of storage nodes. The grouping or partitioning of the storage nodes can be based on pre-configured data storage policies, such as fault tolerance policies. For example, a fault tolerance policy (e.g., a redundant array of independent disks policy or a RAID policy) may require that multiple duplicates of a same data component be stored in different storage nodes (e.g., nodes 210A and 210B) such that data would not be lost because of a failure of one storage node containing one duplicate of the data component. Such a policy thus provides fault tolerance using data redundancy. In the above example, each duplicate of the entire data component can be stored in one storage node (e.g., node 210A or node 210B). As described in more detail below, in some embodiments, multiple subcomponents of a data component or duplicates thereof can be stored in multiple storage nodes using dynamic partitioning techniques, while still in compliance with the fault tolerance policy to provide data redundancy and fault tolerance. For example, a particular data component may have a size that is greater than the storage capacity of a single storage node (e.g., 256 Gb). Using the dynamic partitioning techniques, the data component can be divided to multiple smaller subcomponents and stored in multiple storage nodes. A data structure (e.g., a hash map) for the subcomponents is determined and maintained for efficient data resynchronization. It should be appreciated that multiple data components can be stored in a storage node. In addition, data structures for the subcomponents of the multiple data components can be determined and maintained for efficient data resynchronization.

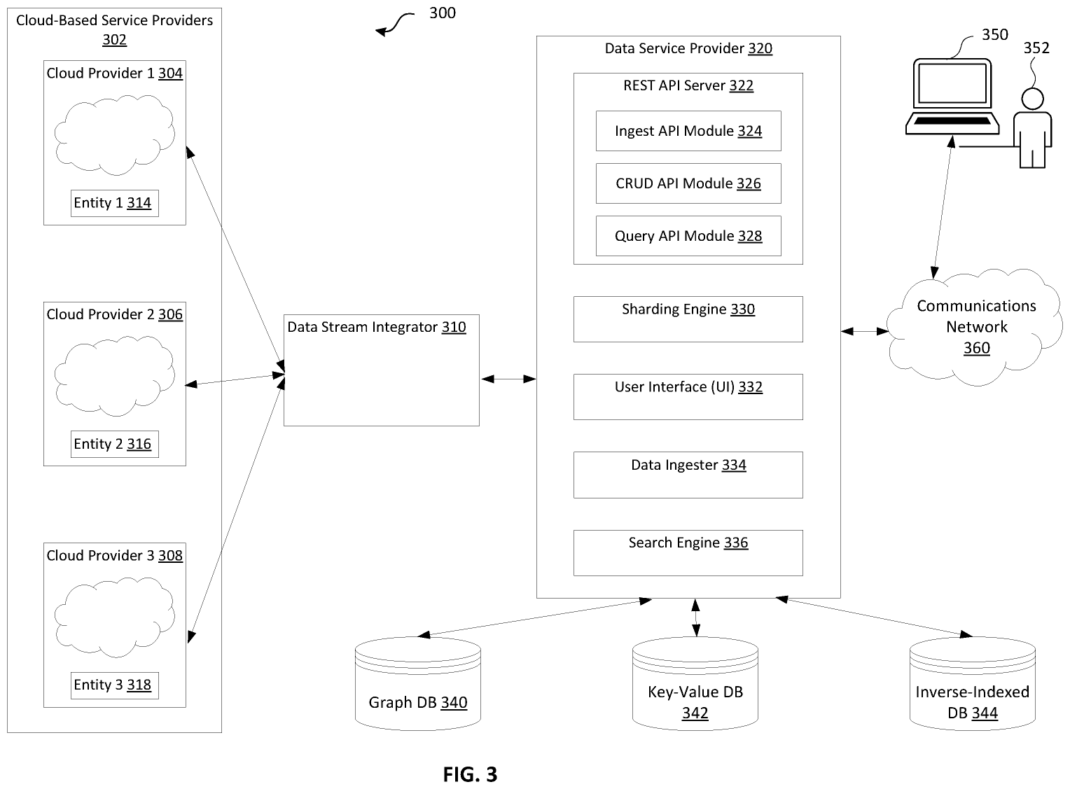

FIG. 3 is a block diagram illustrating a system 300 enabling entity data services, in accordance with some embodiments. System 300 may include a data service provider 320 that provides entity data services to one or more computing devices, such as but not limited to user-computing device 350. A user 352 of a group of users may employ the user-computing device 350 to monitor and/or manage the group's cloud, and the entities comprising the cloud. More specifically, the user 252 may provide, via computing device 350, data service provider 320 with a query regarding the one or more entities of the group's cloud. In response, data service provider 320 may provide, via computing device 350, the user 352 with the search results based on the query. Communications network 360 may communicatively couple computing device 350 and data service provider 350. Such a communicative coupling enables electronic communication between computing device 350 and data service provider 320.

As noted throughout, the entities comprising the group's cloud may be provided by a set of cloud-based service providers 302. The entities may be virtualized entities (e.g., VMs, virtualized storage disks, virtualized network components, and the like). In the non-limiting example of FIG. 3, the set of cloud-based service providers 302 may include at least three cloud providers: first cloud provider 304, second cloud provider 306, and third cloud provider 308. Each of the cloud service providers may provide at one or more entities to users of the group. For instance, first cloud provider 304 may provide at least a first entity 314 (e.g., a VM), second cloud provider 306 may provide at least a second entity 316 (e.g., a virtualized storage disk), and third cloud provider 308 may provide at least a third entity 318 (e.g., user authentication services). Cloud-based service providers 302 may include, but are not limited to Amazon Web Services, Microsoft Azure, Google Cloud, and the like.

System 300 may include a data stream integrator 310. As shown in FIG. 3, each of the cloud-based service providers 302 may provide streaming data regarding their provided entities, in the form of a data stream, to a data stream integrator 310. The streamed data may include current state information pertaining to the provided entities. The data stream integrator 310 may be communicatively coupled to each of the cloud-base service providers 302 via the communications network 360, one or more local area networks, and/or a combination thereof. In some non-limiting embodiments, the data stream integrator 310 may include and/or employ a data stream service, such as but not limited to Amazon Kinesis. The data stream integrator 310 may collect, aggregate, process, and/or at least partially analyze (e.g., preprocess) the data streams from the cloud providers. The data stream integrator 310 may package and/or format the data stream into one or more data structures. In various embodiments, at least a portion of the data may be packaged into an entity data structure. At least a portion of the data stream may be packed into a relationship data structure. As shown in FIG. 3, the data stream integrator 310 may provide the collected, aggregated, processed, analyzed, and/or formatted data stream to the data service provider 320.

System 300 may include one or more databases. In the non-limiting embodiment of FIG. 3, system 300 includes three databases: a first database, a second database, and a third database. In some embodiments, the first database may be a graph database 340, the second database may be a key-value database 342, and the third database may be an inverse (or Lucene) indexed database 344. The data service provider 320 may be communicatively coupled to each of the databases of system 300, as well as each of the cloud-based service providers 302 and the data stream integrator 310 via the communications network 360, one or more local area networks, and/or a combination thereof.

Graph database 340 may encode a graph representation of the current entities, as well as various relationships between the current entities. In various embodiments, each of the group's entities may be represented by a corresponding node in the graph. Relationships between the entities may be represented by directed or undirected edges between the corresponding nodes. System 300 may employ a data model (discussed below) that supports dynamic schema modeling, where the schema may be configured at runtime. The data model may include at least a first data structure (e.g., an entity data structure) and a second data structure (an entity relationship data structure). Thus, the nodes of the graph may be encoded in the entity data structure and the edges of the graph may be encoded in an entity relationship data structure. In various embodiments, the graph database 340 may be implemented on a cloud-based database provider. For instance, graph database 340 may be implemented on Amazon Neptune, or another such cloud-based graph database provider. In some embodiments, graph database 340 may support a graph traversal query language, such as but not limited to the Gremlin language. In some embodiments, the graph database may primarily store data that is current (via the entity and entity relationship data structures), with respect to the group's current entities.

Key-value database 342 may include a key-value store that persistently stores information relating to the group's entities. In contrast to the graph database 340 which is directed at storing the group's current entities and current relationships amongst the current entities, key-value database 342 may persistently store historical information regarding the group's current and historical entities, as well as preserving the historical and current relationships between the entities. Key-value database 342 may be a NoSQL database that supports structuring data as key-value pairs. In some embodiments, the keys and corresponding values stored in the key-value database 342 may be the keys and values of the entity and entity relationship data structures. In various embodiments, key-value database 342 may be implemented by a cloud-based database provider. For instance, key-value database 342 may be implemented by Amazon DynamoDB, or another such cloud-based database provider.

Inverse-indexed database 344 may be a globally reverse-indexed database that stores at least portions of the data stream in a document data structure, such that the group's entity data may be globally searched, aggregated, and analyzed. In some embodiments, reverse-indexed database 344 may be a Lucene-indexed database. The entity and entity relationship data stored in a document data structure in the reverse-indexed database 344 may be globally searchable via a search engine. In at least one embodiment, the inverse-indexed database 344 may be implemented via search and analytics provider. For example, inverse-indexed database 344 may be implemented via Elasticsearch. In such embodiments, the inverse-indexed database 344 may be searched, and the search results may be aggregated and analyzed via all the capabilities that an Elastisearch-based system provides.

Some embodiments may be based on a representation state transfer (REST)-based architecture. Thus, these embodiments may support RESTful application programming interfaces (APIs) to implement at least some of its functionality. As such, data service provider may include a REST API server 322. The REST API server 322 may include an ingest API module 324, a create, read, update, and delete (CRUD) API module 326, and a query API module 328. The REST API server 322 is generally responsible for receiving and servicing RESTful API calls pertaining to various query functions of the system 300. The ingest API module 324 is generally responsible for serving ingest API calls, which act to format and ingest the received data stream into the various databases. In some embodiments, one ingest API call may enable the bulk updating of the databases with the data received from the data stream. More specifically, via ingest APIs; system 300 may accept updates to the databases for multiple entities and multiple relationships between the entities, from multiple cloud-based service providers 302. Thus, system 300 provides for updating multiple databases with data from multiple cloud providers for multiple entities, which encodes relationships between the multiple entities from separate cloud providers. The CRUD API module 326 is generally responsible for receiving and servicing CRUD API calls that enable the creation, reading (or access), updating, and deleting of entities. Such CRUD APIs may not be specific to a specific cloud provider. Thus, user 352 may employ a single set of CRUD API calls to perform CRUD-type operations on entities from multiple providers.

Query API module 328 is generally responsible for receiving and servicing query API calls. For example, user 352 may provide a query API call to search one or more of the databases. Such query API calls include, but are not limited to functions calls for querying one or more of the databases. Such querying APIs support rich filtering, paginations, and sorting of the query results. Note that these query APIs need not be cloud provider specific. That is, the query APS, as well as the ingest and CRUD APIs may be agnostic as to the provider of the entities. Thus, the user 352 may employ a single uniform set of query APIs to query entities from separate cloud providers. Some query API calls may enable traversing and exploring the entities and relationships between entities, via traversing and exploring the graph database 340. Query APIs specific to the graph database 340 may be coded in a graph traversal language, such as but not limited to the Gremlin language. Graph-related APIs may additional enable querying the graph to determine a degree of centrality and/or connectedness for a set of the entities. Query APIs may support aggregations and sub-aggregations of the entity data, as well as filtering of the data.

As discussed throughout, the data service provider 320 may format and store at least portions of the data stream received from the data stream integrator 310 into each of the databases included in the system 300. In some embodiments, subsets of the data stream are stored in the separate databases. In some embodiments, there may be at least some overlap in the subsections of the data stored in the separate databases. Data service provider 320 may include a data ingestor 334 that is generally responsible for ingesting the data stream, formatting the data stream, and/or generating the subsets of the formatted data stream to insert in the databases. Data ingestor 334 may receive ingest API calls from the ingest API module. Via ingest API calls; system 300 may ingest entity-related data that encodes various state information of the entities and the relationships between the entities. Such ingest API calls may enable bulk updating of the databases, with regards to entities from multiple cloud providers.

The data ingestor 334 (or the data stream integrator 310) may format the data into one or more data structures for insertion into the databases. In at least one embodiment, the data structure may be a JavaScript object that is encoded in JavaScript Object Notation (JSON). A JSON object may encode data for the object as key-value pairs. In some embodiments, at least two data structures may be employed. A first data structure may encode an entity, while a second data structure may encode relationships between the entities. The entity data structure may encode an entity as a JSON object. Some of the keys in an entity data structure may include, but are not limited to, a graph identifier, an entity identifier, an entity type, a user identifier, a service identifier, a provider identifier, one or more tags, one or more properties, a creation timestamp, and a last updated timestamp. The value for the graph identifier key may indicate which graph the entity is located in, the value for the entity identifier key may indicate which entity is encoded, and the value for the entity type key may indicate an entity type for the entity. The value for the user identifier may indicate which user owns the entity. In some embodiments, the user identifier key may alternatively be an identifier for a cloud account. A cloud account may indicate a user or a container associated with the entity. The value for the region key may indicate a geographical region that the entity is located in, the value for the service key may indicate a service provided by the entity, and the value for the provider key may indicate a cloud-based provider that is providing the entity. The tag key may be paired with one or more values for providing one or more descriptive tags for the entity. The properties key may be paired with one or more values providing descriptions of one or more properties of the entity. The value for the creation timestamp key may indicate a time and date that the entity was created, while the value for the last updated timestamp may indicate the time and date that the entity was last updated.

In some embodiments, the entity relationship may encode an entity as a JSON object. Some of the keys in an entity data structure may include, but are not limited to, a graph identifier, a relationship identifier, a relationship type, a source entity identifier, a foreign entity identifier, relationship properties, a creation timestamp, and a last updated timestamp. The value for the relationship identifier key may indicate which graph the entity relationship is located in, the value for the relationship identifier key may indicate which relationship is encoded, and the value for the relationship type key may indicate a relationship type for the relationship. The values for the source entity identifier and the foreign entity identifier may indicate which entities the relationship is between. In some embodiments, entities identified by these keys may indicate a direction of the relationship (e.g., parent vs child entities). Thus, for directed relationships, the edge may be directed from the source entity to the foreign entity. The properties key may be paired with one or more values providing descriptions of one or more properties of the relationship. The value for the creation timestamp key may indicate a time and date that the relationship was created, while the value for the last updated timestamp may indicate the time and date that the relationship was last updated.

In some embodiments, data service provider 320 may include a sharding engine 330. The sharding engine 330 may be generally responsible for sharding each of the databases. Each of the databases may be intelligently sharded to ensure efficient lookups when servicing a query or another API call. That is, each of the databases may be intelligently partitioned into a plurality of shards or database slices, based on the group of users and the data, such that queried data may be efficiently located and retrieved from the databases. One or more policies of the group may indicated a sharding strategy for the databases. A policy may define one or more heuristics that indicates on which portions of the data content and/or data structures to partition the databases along. For instance, a policy may indicate a key for which to shard the database along. The sharding may be performed at the group or organizational level, the cloud account level, or the like.

In some embodiments, data service provider 320 may include a search engine 336. The search engine may be employed to perform a search on the databases. In some embodiments, the search engine may be an elasticsearch engine. Data service provider 320 may include a user interface (UI) component 332. The UI component 332 may provide an interface for user 352 to interact with the entity data services.

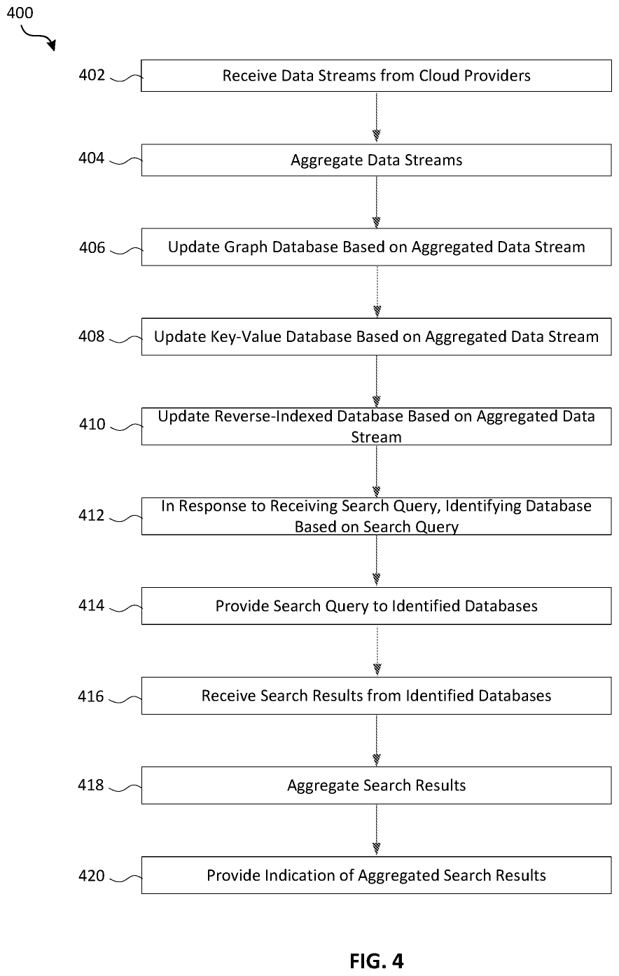

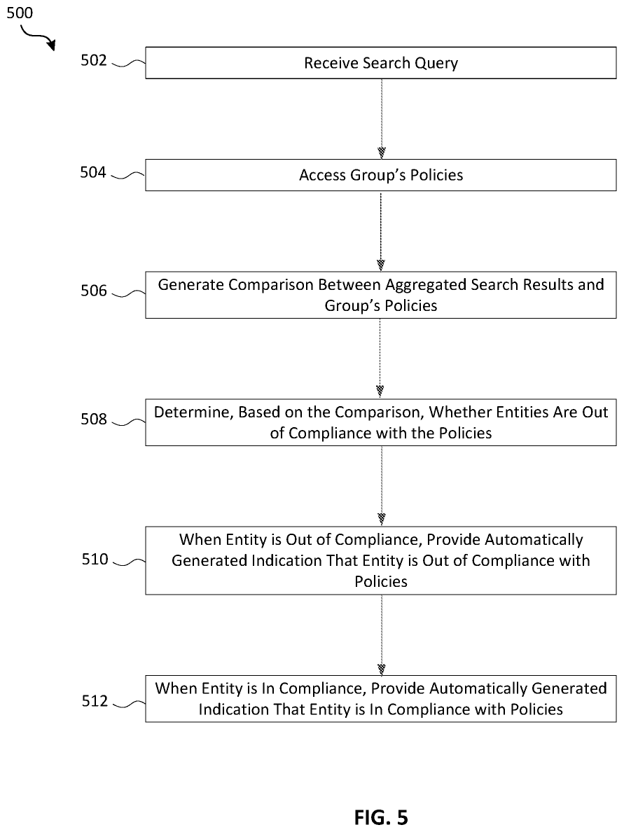

FIGS. 4-5 illustrate flowcharts for exemplary processes 400-500, in accordance with some embodiments Processes 400-500 are performed, for example, at one or more components in the cloud-computing environment. In some embodiments, the distributed-computing system comprises a plurality of storage nodes or host computing devices (e.g., host computing device 100 described in reference to FIG. 1A) that are communicatively coupled together in a vSAN. In some embodiments, the distributed-computing system is implemented by one or more virtual machines (e.g., VM 102 described in reference to FIGS. 1A-1B). The distributed-computing system implements, for example, any of the components discussed in conjunction with system 300 of FIG. 3 (e.g., data service system). In some embodiments, the operations of any of processes 400-500 are distributed across the various systems (e.g., system 300) of the distributed-computing system. In processes 400-500, some blocks are, optionally, combined, the order of some blocks is, optionally changed, and some blocks are, optionally omitted. In some embodiments, additional operations may be performed in combination with any of processes 600-700.

FIG. 4 illustrates a flowchart of an exemplary process 400 for providing entity-related data services, in accordance with some embodiments. Process 400 begins at step 402, where one or more data streams are received. The data streams may encode current state-information regarding entities, such as physical or virtualized entities. The entities may be provided by one or more cloud providers (e.g., virtualized entity providers). The data streams may be received by a data stream integrator (e.g., data stream integrator 310 of FIG. 3). At block 404, the data streams may be aggregated. Aggregating the data streams may include collecting, integrating, processing, and/or at least partially analyzing (e.g., preprocessing) the data streams from the cloud providers. The data streams may be packaged and/or formatted into one or more data structures. In various embodiments, at least a portion of the data may be packaged into an entity data structure. At least a portion of the data stream may be packed into a relationship data structure.

At block 406, a graph database (e.g., graph database 340 of FIG. 3) may be updated based on the received data stream. That is, at least a portion of the data stream may be inserted into (or ingested by) the graph database. The graph database may store current graph data that indicates current relationships between the entities. The graph database may store the graph data via the entity data structure and the relationship data structure. At block 408, a key-value database (e.g., key-value database 342 of FIG. 3) may be updated based on the received data stream. The key-value database may persistently store historical entity data for the group of users. At block 410, a reverse-indexed database may be updated based on the received data stream. The reverse-indexed database may store globally-searchable current entity data for the entities of the group.

At block 412, and in response to receiving a search query, one or more of the three databases may be identified based on the content of the query. At block 414, the search query may be provided to each of the identified databases. At block 416, search results may be received from each of the identified databases. At block 418, the search results may be aggregated. The aggregated search results may encode a status of at least a first entity of the group's entities. At block 420, an indication of the search results may be provided. For example, an indication of the status of the first entity may be provided to a user that provided the search query.

FIG. 5 illustrates a flowchart of an exemplary process 500 for providing automated entity-compliance services, in accordance with some embodiments. In some embodiments, the search query received at block Process 500 begins at step 502, where a search query is received. The search query may have been automatically generated and/or provided by a compliance scheduling system and/or service. The query may indicate a request to determine whether one or more of the group's entities are currently out of compliance with policies of the group. The received query may be provided to one or more databases, based on the content of the query, as discussed in conjunction with process 400. In addition, at block 502, aggregated search results may be received, as discussed in conjunction with process 400. At block 504, the group's policies may be accessed. At block 506, a comparison between the aggregated search results and the accessed policies may be generated. At block 508, it may be determined whether any of the group's entities are out of compliance with one or more of the group's policies. At block 510, when an entity is out of compliance with one or more of the policies, an automatically generated indication that the entity is out of compliance with a policy may be provided. At block 512, when none of the entities are out of compliance, an automatically generated indication that the entities comply with the policies may be provided.

In accordance with some implementations, a computer-readable storage medium (e.g., a non-transitory computer-readable storage medium) is provided, the computer-readable storage medium storing one or more programs for execution by one or more processors of an electronic device, the one or more programs including instructions for performing any of the methods or processes described herein.

The foregoing descriptions of specific embodiments have been presented for purposes of illustration and description. They are not intended to be exhaustive or to limit the scope of the claims to the precise forms disclosed, and it should be understood that many modifications and variations are possible in light of the above teaching.

What is claimed is:

1. A method for providing virtualized entity-related data services to a group of users of a distributed computing system, the method comprising:
receiving a data stream encoding current state-information of a plurality of virtualized entities, wherein each virtualized entity of the plurality of virtualized entities is provided by one or more virtualized-entity providers of a set of virtualized-entity providers;
updating, based on the received data stream, a graph database configured to store current graph data that indicates a plurality of current relationships between virtualized entities of the plurality of virtualized entities;
updating, based on the received data stream, a key-value database configured to store historical virtualized entity data for the group of users;
updating, based on the received data stream, a reverse-indexed database configured to store globally-searchable current entity data for the plurality of virtualized entities;
in response to receiving a query, identifying one or more databases of the graph, key-value, and reverse-indexed databases based on content of the query;
providing the query to the one or more identified databases;
in response to providing the query to the one or more identified databases, receiving search results from each of the one or more identified databases;
aggregating the search results received from each database of the one or more identified databases, wherein the aggregated search results encode a status of at least a first virtualized entity of the plurality of virtualized entities; and
providing, to one or more users of the group of users, an indication of the status of the first virtualized entity.

2. The method of claim 1, further comprising:
receiving the query, wherein the received query indicates a request to determine whether the first virtualized entity is currently out of compliance with one or more entity policies of group of users;
generating a comparison between the aggregated search results and the one or more entity policies of the group of users;
determining, based on the comparison between the aggregated search results and the one or more policies, that the first virtualized entity is out of compliance with a first policy of the one or more entity policies; and
providing the indication of the status of the first entity, wherein the indication of the status of the first policy indicates that the first entity is out of compliance with the first policy.

3. The method of claim 2, wherein the query was automatically generated by a compliance-monitoring scheduling service.

4. The method of claim 1, wherein at least one of the graph, key-value, and reverse-indexed databases is partitioned into a plurality of database slices.

5. The method of claim 1, further comprising:
formatting a first portion of the received data stream in a first data structure, wherein the first portion of the data stream indicates one or more properties of the first virtualized entity;
formatting a second portion of the received data stream in a second data structure, wherein the second portion of the data stream indicates one or more properties of a second virtualized entity of the plurality of virtualized entities;
formatting a third portion of the received data stream in a third data structure, wherein the third portion of the data stream indicates one or more relationships between the first virtualized entity and the second virtualized entity; and
updating the graph database to include the first, second, and third data structures.

6. The method of claim 5, wherein the first, second, and third data structures are JavaScript objects encoded in JavaScript Object Notation (JSON).

7. The method of claim 1, wherein the query is comprised of a graph traversal language syntax.

8. The method of claim 1, further comprising:
employing a virtualized data center to provide the indication of the status of the first virtualized entity, wherein the virtualized data center implements at least one of a virtual storage area network (vSAN), a virtual disk file system (vDFS), or a virtual machine (VM).

9. The method of claim 1, further comprising:
employing an elasticsearch engine to search the reverse-indexed database.

10. The method of claim 1, wherein the query is received as an application programming interface (API) call.

11. A non-transitory computer-readable storage medium storing one or more programs configured to be executed by one or more processors, the one or more programs including instructions for providing virtualized entity-related data services to a group of users of a distributed computing system, the instructions comprising instructions for:
receiving a data stream encoding current state-information of a plurality of virtualized entities, wherein each virtualized entity of the plurality of entities is provided by one or more virtualized-entity providers of a set of virtualized-entity providers;
updating, based on the received data stream, a graph database configured to store current graph data that indicates a plurality of current relationships between virtualized entities of the plurality of virtualized entities;
updating, based on the received data stream, a key-value database configured to store historical virtualized entity data for the group of users;
updating, based on the received data stream, a reverse-indexed database configured to store globally-searchable current entity data for the plurality of virtualized entities;
in response to receiving a query, identifying one or more databases of the graph, key-value, and reverse-indexed databases based on content of the query;
providing the query to the one or more identified databases;
in response to providing the query to the one or more identified databases, receiving search results from each of the one or more identified databases;
aggregating the search results received from each database of the one or more identified databases, wherein the aggregated search results encode a status of at least a first virtualized entity of the plurality of virtualized entities; and
providing, to one or more users of the group of users, an indication of the status of the first virtualized entity.

12. The storage medium of claim 11 further comprising instructions for:
receiving the query, wherein the received query indicates a request to determine whether the first virtualized entity is currently out of compliance with one or more entity policies of the group of users;
generating a comparison between the aggregated search results and the one or more entity policies of the group of users;
determining, based on the comparison between the aggregated search results and the one or more policies, that the first virtualized entity is out of compliance with a first policy of the one or more entity policies; and
providing the indication of the status of the first entity, wherein the indication of the status of the first policy indicates that the first entity is out of compliance with the first policy.

13. The storage medium of claim 12, wherein the query was automatically generated by a compliance-monitoring scheduling service.

14. The storage medium of claim 11, wherein at least one of the graph, key-value, and reverse-indexed databases is partitioned into a plurality of database slices.

15. The storage medium of claim 11 further comprising instructions for:
formatting a first portion of the received data stream in a first data structure, wherein the first portion of the data stream indicates one or more properties of the first virtualized entity;
formatting a second portion of the received data stream in a second data structure, wherein the second portion of the data stream indicates one or more properties of a second virtualized entity of the plurality of virtualized entities;
formatting a third portion of the received data stream in a third data structure, wherein the third portion of the data stream indicates one or more relationships between the first virtualized entity and the second virtualized entity; and
updating the graph database to include the first, second, and third data structures.

16. The storage medium of claim 15, wherein the first, second, and third data structures are JavaScript objects encoded in JavaScript Object Notation (JSON).

17. The storage medium of claim 11, wherein the query is comprised of a graph traversal language syntax.

18. The storage medium of claim 11 further comprising instructions for:
employing a virtualized data center to provide the indication of the status of the first virtualized entity, wherein the virtualized data center implements at least one of a virtual storage area network (vSAN), a virtual disk file system (vDFS), or a virtual machine (VM).

19. The storage medium of claim 11 further comprising instructions for:
employing an elasticsearch engine to search the reverse-indexed database.

20. The storage medium of claim 11, wherein the query is received as an application programming interface (API) call.

21. A distributed computing system for providing virtualize entity-related data services to a group of users, the system comprising:
one or more processors; and
a memory storing one or more programs configured to be executed by the one or more processors, the one or more programs including instructions for performing operations comprising:
receiving a data stream encoding current state-information of a plurality of virtualized entities, wherein each virtualized entity of the plurality of entities is provided by one or more virtualized-entity providers of a set of virtualized-entity providers;
updating, based on the received data stream, a graph database configured to store current graph data that indicates a plurality of current relationships between virtualized entities of the plurality of virtualized entities;
updating, based on the received data stream, a key-value database configured to store historical virtualized entity data for the group of users;
updating, based on the received data stream, a reverse-indexed database configured to store globally-searchable current entity data for the plurality of virtualized entities;
in response to receiving a query, identifying one or more databases of the graph, key-value, and reverse-indexed databases based on content of the query;
providing the query to the one or more identified databases;
in response to providing the query to the one or more identified databases, receiving search results from each of the one or more identified databases;
aggregating the search results received from each database of the one or more identified databases, wherein the aggregated search results encode a status of at least a first virtualized entity of the plurality of virtualized entities; and
providing, to one or more of the group of users, an indication of the status of the first virtualized entity.

22. The system of claim 21, wherein the operations further comprises:
receiving the query, wherein the received query indicates a request to determine whether the first virtualized entity is currently out of compliance with one or more entity policies of the group of users;
generating a comparison between the aggregated search results and the one or more entity policies of the group of users;
determining, based on the comparison between the aggregated search results and the one or more policies, that the first virtualized entity is out of compliance with a first policy of the one or more entity policies; and
providing the indication of the status of the first entity, wherein the indication of the status of the first policy indicates that the first entity is out of compliance with the first policy.

23. The system of claim 22, wherein the query was automatically generated by a compliance-monitoring scheduling service.

24. The system of claim 22, wherein at least one of the graph, key-value, and reverse-indexed databases is partitioned into a plurality of database slices.

25. The system of claim 21, wherein the operations further comprises:
formatting a first portion of the received data stream in a first data structure, wherein the first portion of the data stream indicates one or more properties of the first virtualized entity;
formatting a second portion of the received data stream in a second data structure, wherein the second portion of the data stream indicates one or more properties of a second virtualized entity of the plurality of virtualized entities;
formatting a third portion of the received data stream in a third data structure, wherein the third portion of the data stream indicates one or more relationships between the first virtualized entity and the second virtualized entity; and
updating the graph database to include the first, second, and third data structures.

26. The system of claim 25, wherein the first, second, and third data structures are JavaScript objects encoded in JavaScript Object Notation (JSON).

27. The system of claim 21, wherein the query is comprised of a graph traversal language syntax.

28. The system of claim 21, wherein the operations further comprises:
employing a virtualized data center to provide the indication of the status of the first virtualized entity, wherein the virtualized data center implements at least one of a virtual storage area network (vSAN), a virtual disk file system (vDFS), or a virtual machine (VM).

29. The system of claim 21, wherein the operations further comprises:
employing an elasticsearch engine to search the reverse-indexed database.

30. The system of claim 21, wherein the query is received as an application programming interface (API) call.
